(19) United States
(12) Patent Application Publication
(10) Pub. No.: US 2026/0016673 A1
(43) Pub. Date: Jan. 15, 2026

(54) FOUNDATION MODEL-ASSISTED PROCESSING OF MICROSCOPE IMAGES

(71) Applicant: Carl Zeiss Microscopy GmbH, Jena (DE)

(72) Inventors: Manuel AMTHOR, Jena (DE); Daniel HAASE, Zoellnitz (DE); Ralf WOLLESCHENSKY, Jena (DE)

(73) Assignee: Carl Zeiss Microscopy GmbH, Jena (DE)

(21) Appl. No.: 19/267,968

(22) Filed: Jul. 14, 2025

(30) Foreign Application Priority Data
Jul. 15, 2024 (DE) 102024120077.4

(51) Int. Cl. G02B 21/00

(52) U.S. Cl. CPC G02B 21/008; G02B 21/0016

(57) ABSTRACT

Techniques for controlling a microscopy system and for processing microscope images are disclosed. In this context, a user input in free-text format is processed in order to create a prompt for a machine-learned text-to-text foundation model. The output of the foundation model can be used subsequently to solve an image processing task or for controlling the microscopy system.

### FIELD OF THE INVENTION

Various examples in the disclosure relate to techniques for the computer-implemented processing of microscope images. According to various examples in the disclosure, use is made of a foundation model in particular, in order to create program code that is capable of processing microscope images. The program code can subsequently be run in order to solve an image processing task.

### BACKGROUND OF THE INVENTION

Microscope images find use in numerous fields of application. By way of example, reference is made here to material testing of technical test objects, for example optical test objects or textiles, and the inspection of electronic circuits. Microscope images are also used in the field of biology, for example for examining biological samples. Within these fields of application, there are numerous conceivable applications. For example, the examination of both cell cultures and tissue samples may be required within the scope of examining biological samples. Counting specific cell types may be important when examining cell cultures. In this context, consideration should be given to the fact that, depending on the type of cell culture, different cell types can be counted. Other problems may also be relevant in addition to counting cells, for example the determination of the degree of confluence of cells or the identification of atypical cells (anomalies can be identified). When examining tissue samples, the creation of a digital contrast for different cell types may be advantageous. For example, chemical staining may be replaced by digital contrasts. The list of fields of application and applications within the fields of application given above is by no means comprehensive. The list only serves to illustrate the numerous fields of application and, within the fields of application, the numerous conceivable image processing tasks. In particular, it was observed that users often formulate user-specific image processing tasks.

In principle, there are numerous image processing algorithms available that may be drawn upon to solve specific image processing tasks. For example, libraries of basic operations, which may be applied to images, are available in various programming languages. However, such relatively abstract or generic operations do not always fit directly to a specific image processing task. The creation of appropriate program code for solving a relatively complex image processing task requires programming knowledge and knowledge about the libraries and operations available should use be made of libraries and operations that are not tailored to the respective image processing task. This represents a significant hurdle, especially for users with little experience, and prevents the timely solution to specific image processing tasks.

### SUMMARY OF THE INVENTION

There is a need for improved techniques for processing microscope images. In particular, there is a need for techniques that flexibly enable different applications and practical use cases. There is also a need for techniques that are capable of flexibly processing different types of microscope images. For example, there is a need for techniques capable of processing microscope images with different contrasts or imaging modalities. There is a need for techniques that allow an adaptation of corresponding algorithms for image processing tasks that is tailored to an individual user.

Techniques are described below which, on the basis of a captured microscope image, allow a user of a microscope to use natural language to describe how the microscope image should be processed. Subsequently, the user receives an appropriate evaluation, for example the further-processed microscope image, as a result.

A computer-implemented method is disclosed. This method serves to process microscope images. This method comprises the reception of a microscope image. Moreover, the method comprises the reception of a user input in free-text format. In this case, the user input is indicative of at least one image processing task. The at least one image processing task serves for the evaluation or manipulation of microscopic structures displayed in the microscope image. Moreover, the method comprises the triggering of the use of a machine-learned text-based foundation model for creating program code that allows the image processing task to be solved. This triggering of the use of the machine-learned text-based foundation model is based on the user input. The method also comprises the triggering of an execution of the program code and, on the basis thereof, the reception of results data.

A computer-implemented method for controlling a microscopy system for performing a microscopy task is also disclosed. The microscopy task comprises at least one of an image capture of a microscope image, a display of a microscope image and an image processing of a microscope image. In this context, the method comprises the reception of a user input in free-text format. The user input is indicative of the microscopy task. Moreover, the method also comprises the triggering of the use of a machine-learned text-based foundation model for creating a control instruction for the microscopy system. The use of the machine-learned text-based foundation model is based on the user input in this case. The method also comprises the control of the microscopy system on the basis of the control instruction.

An electronic data processing device having a processor and a memory is also disclosed. The processor is configured to load program code from the memory and run said program code. The processor is also configured to run one or more of the above-described methods based on running the program code.

The features set out above and features described below can be used not only in the corresponding combinations explicitly set out, but also in further combinations or in isolation, without departing from the scope of protection of the present invention.

### BRIEF DESCRIPTION OF THE DRAWINGS

FIG. 1 is a flowchart of one exemplary method.

FIG. 2 schematically shows an electronic data processing device according to various examples.

### DETAILED DESCRIPTION OF THE INVENTION

The properties, features and advantages of this invention described above and the way in which they are achieved will become clearer and more clearly understood in association with the following description of the exemplary examples which are explained in greater detail in association with the drawings.

The present invention is explained in detail below on the basis of preferred examples with reference to the drawings. In the figures, identical reference signs denote identical or similar elements. The figures are schematic representations of various examples of the invention. Elements illustrated in the figures are not necessarily illustrated as true to scale. Rather, the various elements illustrated in the figures are rendered in such a way that their function and general purpose become comprehensible to a person skilled in the art. Connections and couplings between functional units and elements illustrated in the figures may also be implemented as an indirect connection or coupling. A connection or coupling may be implemented in a wired or wireless manner. Functional units may be implemented as hardware, software or a combination of hardware and software.

Techniques for controlling a microscopy system are described below. For example, specific image capturing modalities may be set for the microscopy system using the techniques described herein. For example, it would be conceivable that microscope images captured by means of the microscopy system are processed using the techniques described herein.

The methods presented in this text allow image processing tasks to be solved. In principle, it is possible to solve structure-based image processing tasks and also image processing tasks that are abstract vis-à-vis the microscopic structures imaged in the microscope image. An example for the solution of structure-based image processing tasks is the evaluation or manipulation of microscopic structures displayed in a microscope image. In this context, the term “structure-based” should not be understood as a variation of an abstract image contrast but instead denotes the evaluation of information concerning the microscopic structures that are displayed within a microscope image. Examples of such problems include the counting of structures of a specific type, the segmentation of structures of a specific type, the classification of displayed microscopic structures, and so on. In addition to such image processing tasks, which are directed to specific microscopic structures, it would however also be possible to apply abstract image processing tasks that are independent of the displayed microscopic structures. Denoising an image or the manipulation of a brightness histogram may be listed as examples in this context.

The techniques described herein allow the control of a microscopy system using a text-based machine-learned model. In particular, it is possible to use a large generative language model (referred to hereinafter as text-based foundation model). This typically operates on the basis of deep learning and what is known as the transformer architecture. It comprises a plurality of layers, which each contain what are known as “self-attention” mechanisms. These mechanisms allow the model to identify relationships and importances between different words in a text. The input data initially pass through an embedding, which converts each word into a feature vector. These feature vectors are then processed by the transformer layer, in which the self-attention mechanisms are used. The output layer of the model determines the most probable next word in a sentence.

A foundation model typically has a large number of parameters. For example, the foundation model might have no less than E9 or E10 parameters, the values of which are set while the foundation model is trained. The foundation model training may also be based on a particularly large number of training data—also on account of the large number of free parameters. For example, such training data may be collected from sources that are associated with a plurality of domains. Unsupervised learning may be performed, wherein the text-based foundation model learns to predict the respective next words in a text on the basis of the available texts from the training data. User-annotated labels are not required.

Various examples are based on the insight that text-based foundation models are often very well suited to the creation of program code. Accordingly, the present invention includes the description of techniques of how program code can be created by means of a text-based foundation model, said code implementing or creating a control instruction for the microscopy system and/or being capable of solving a structure-based image processing task.

Various examples are based on the insight that text-based foundation models are often also able to process inputs in image formats in addition to text but are unable to process image format input in a targeted manner. Therefore, text-based foundation models are often not suitable for directly solving image processing tasks or creating control instructions for a microscopy system that have a close connection to the processing of images. Then again, text-based foundation models are well suited to understanding text-based user inputs in free-text format. Accordingly, the following discloses techniques that interpret the user input in natural language, i.e. in free-text format, in order to create control instructions for a microscopy system or, in particular, program code for solving an image processing task.

However, according to various examples, the user does not interact directly with the text-based foundation model. Rather, an intermediate layer is used, the latter translating the user input into a prompt for the foundation model (on the input side of the foundation model). The prompt contains an operating instruction for the foundation model.

The intermediate layer may also be used to check or validate the output of the foundation model—i.e. for example a control instruction for the microscopy system and in particular for example also program code for solving an image processing task.

By means of such techniques, which use a foundation model optionally with an intermediate layer, users are able to interact particularly easily with a microscopy system. The implementation of user-specific control tasks for the microscopy system is possible without in-depth programming knowledge. Moreover, it is possible to solve user-specific image processing tasks without the user themselves needing to program corresponding program code. This makes it possible to solve specific problems which previously could not be solved or only solved under more difficult conditions or only after several years' worth of training with the corresponding systems. The techniques disclosed herein contribute to a significant simplification of the human-machine interaction.

According to various examples, a microscope image and a text input from a user of the corresponding microscopy system may be received in a first step. In this case, the text input may contain a processing rule for the image in natural language. Then, in a second step, a request or a prompt for a machine-learned text-based foundation model can be created on the basis of this text input and optionally on the basis of the microscopy image. This prompt instructs the foundation model to create a program code which, when run on the microscopy image from the first step, supplies the result requested by the text input. Then, in a third step, inference of the machine-learned text-based foundation model is performed, for example on a cloud server. In a fourth step, the result of the inference of the machine-learned text-based foundation model can be checked. In particular, this may contain the validation whether the program code generated by the machine-learned text-based foundation model is valid. Then, the created program code can be run in a fifth step. To this end, the program code can be compiled, for example, or it is possible to transfer corresponding control instructions to image processing programs. The program code is run in the context of the microscopy image. Subsequently, the results of running the program code can be prepared and checked in a sixth step. For example, it is possible to perform validations, the goal of which lies in identifying faulty solutions to the corresponding image processing task. In a seventh step, the corresponding results data from the sixth step may be output to a user, for example via a graphical user interface. It would optionally be subsequently possible to repeat the preceding steps. In this case, the data created within the scope of the preceding iteration may be used as context information for the foundation model in order to obtain better results in the subsequent iteration.

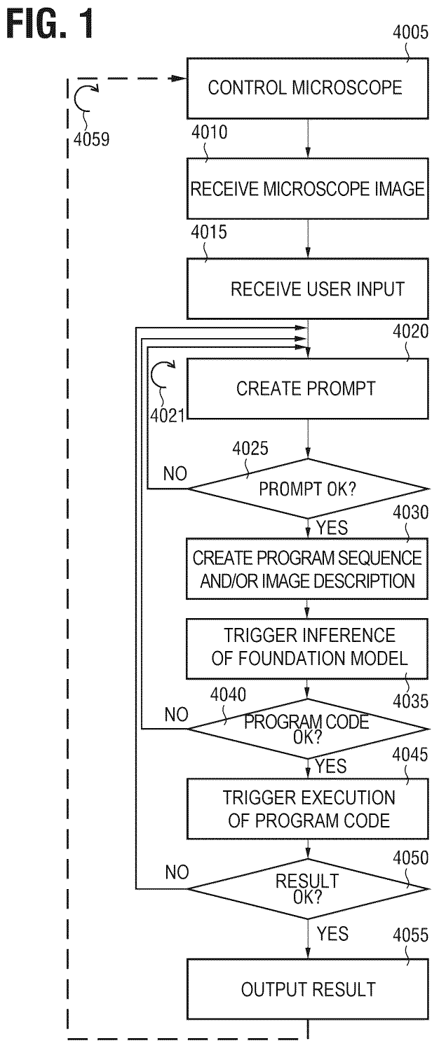

FIG. 1 is a flowchart of one exemplary method. The method from FIG. 1 serves to process microscope images. The microscope images may be captured by means of a microscope, for example by means of a light microscope. The method from FIG. 1 can be run on a computer. For example, a processor may load program code from a memory and run said code such that, subsequently, at least individual steps of the method from FIG. 1 are run. However, individual steps of the method from FIG. 1 may also be run on a server, for example in the cloud.

The microscope is controlled in optional Box 4005. In particular, a command causing a microscope image to be captured is transmitted. The microscope image may be captured with a specific contrast. For example, a phase contrast could be used. Fluorescence imaging could be used. A bright-field contrast could be used. A dark-field contrast could be used. Typically, different magnification factors are available by way of the suitable choice of an objective, and so a corresponding setting may also be transferred.

A microscope image is obtained in Box 4010. While a microscope image is obtained from a microscope after the microscope was controlled to capture the microscope image in the example of FIG. 1, there are also other techniques for obtaining an appropriate microscope image. For example, a microscope image could be obtained by loading the microscope image from an image database. For example, an image archiving system in which different microscope images are stored could be used. Accordingly, the method from FIG. 1 is not limited to controlling a microscope in order to obtain the microscope image.

In general, different types of microscope images can be processed using the techniques disclosed herein. For example, this may relate to two-dimensional image data or else three-dimensional image data. It could also be possible to obtain a time sequence of microscope images which for example represent a specific process with time resolution. For example, the types of contrast may comprise bright-field imaging, phase contrast, a laser scanning microscope, light sheet microscopy, x-ray microscopy, etc. The types of samples to be examined are not specifically limited either, and so it is possible, for example, to examine biological samples, cell cultures, material samples, tissue slices, etc.

In Box 4010, it would optionally be conceivable to perform a preliminary check of the microscope image. For example, a different image evaluation algorithm could be applied to the microscope image in order to perform a check of one or more properties of the microscopic structures. This image evaluation unit is not yet able to solve the user task subsequently posed by the user; however, at the same time it is possible to ensure a certain consistency for various microscope images. Such an evaluation of the microscope image can subsequently be taken into account in the various boxes, for example in Box 4020, Box 4035, etc.

It would also be conceivable that the subsequent boxes are terminated should the preliminary check of the microscope image in Box 4010 yield the discovery that certain requirements in respect of the microscope image have not been satisfied.

A user input is obtained in Step 4015. The user input is available in free-text format. This means that it would for example be possible for the user input to be drafted entirely in natural language. However, it would also be conceivable that at least parts of the user input are available in technical language, for example as program code for an image processing program.

Examples of user inputs are e.g.: “determine the number of dividing cells in the image”; “denoise the data”; “deconvolve SIM raw data. The grating period of the system is 20 μm”; “perform virtual staining on the bright-field data. H&E is the target staining.”; and “segment the area on which cells have grown”.

In general, the user input may be indicative of a structure-based image processing output for evaluating or manipulating microscopic structures displayed in the microscope image. Thus, this means that, at least in some examples, the user input might not relate in general to desired image processing tasks that have no relationship to the semantic content of an image. Instead, the user input in various examples may relate specifically to the depicted content of the image, namely the microscopic structures. For example, examples of such microscopic structures would be semiconductor structures, cell structures, surface defects of optical test objects, etc. The image processing task may relate to an evaluation of properties of such microscopic structures.

As evident above from the specific examples of user inputs, however, not all situations require the user input to be indicative of a structure-based image processing task. General image processing tasks, which are agnostic in relation to the respective structures displayed in the microscope image, could also be specified. For example, an appropriate example is the user input: “denoise the data”. For example, image data may be denoised by means of image processing algorithms that operate independently of the structures illustrated.

Further, the degree of detail with which the user input specifies the structure-based image processing task may differ in various implementation variants. For example, the degree of detail may vary between a specific, technical description on the one hand and an applicative description on the other hand. In the case of a specific technical description, the user may concretely specify how the image processing task should be configured. For example, an example would be: “find all round objects in the image that have a diameter of up to 100 pixels”. An applicative description of the image processing task may go into the respective application in domain-specific fashion; an example would be: “find all dividing cells in the microscope image”.

The user inputs may also specify the result of the image processing task at least implicitly. In this case, different results of the image processing task are conceivable. For example, it would be possible for the image processing task to also output an image as output, and said image can for example be displayed in a manner overlaid on the microscope image. For example, an example of this would be the generation of a segmentation mask, in which individual pixels specify whether the corresponding pixel in the microscope image is or is not part of the segmented region. However, the output of the image processing task need not be an image and may also be present in a different form. Examples would for example include lists or tables, for example with localization information for a plurality of entities of a specific object type, i.e. localization information for cells, for example. Further examples would be the output of a statistic, for example a frequency distribution, etc. Other examples relate to the classification of specific displayed microscopic structures, the description thereof, a number in the context of a regression task, etc.

From the statements above, it is evident that there is great flexibility in the context of the user input. This is rendered possible by the use of the free-text format. Moreover, this is rendered possible by the subsequent use of a text-based foundation model which was trained in domain-overarching fashion and is therefore capable of processing user inputs with very variable content.

In particular, the image processing task may comprise a measuring task for determining one or more properties of the microscopic structures contained in the microscope image. It would also be possible that the image processing task creates a virtual contrast for the microscopic structures in the results image. Examples of such measurement tasks that relate to properties of the microscopic structures would for example include: counting cells; counting defects; counting entities of a specific structure type; creating a frequency distribution for the occurrence of certain variants of a structure type; evaluating shape, color, size, etc. of specific structure types, identifying anomalies or defects; etc. The list above is not formulated in domain-specific fashion. However, it would be possible for the corresponding image processing tasks to be formulated in domain-specific fashion by the user. Examples for a virtual contrast would be for example the creation of a virtual cell color contrast, the creation of a virtual phase contrast, the creation of a list of all cell types, etc.

Box 4020 is subsequently carried out. Box 4020 defines the entrance to a loop. The loop in turn defines a plurality of iterations 4021 for the inference of the foundation model. An appropriate prompt is transmitted to the foundation model in each iteration 4021; this will be explained in detail below. By virtue of a plurality of iterations 4021 being performed, it is possible overall to improve the result of the output of the text-based foundation model. This means that the structure-based image processing task can be solved better. The details regarding this achieved effect will also become evident, in particular in the context of the subsequent description of the various boxes from the loop that defines the plurality of iterations 4021.

A prompt is created in Box 4020. In particular, the prompt is created on the basis of the user input 4015. However, it is possible that further information is used when creating the prompt. For example, the microscope image obtained in Box 4010 could also be taken into account in the creation of the prompt in Box 4020. In an iteration 4021 of Box 4020, the prompt may for example be created on the basis of information from a preceding iteration 4021. For example, in one iteration 4021 of Box 4020, it would be conceivable that the prompt is created on the basis of the output of the foundation model in the preceding iteration 4021. In an alternative to that or in addition, it would also be possible for the prompt in one iteration 4021 of Box 4020 to also be created on the basis of the corresponding prompt from the preceding iteration 4021 of Box 4020. Further techniques for creating the prompt in Box 4020 contain the results-oriented creation of the prompt. Thus, in the current iteration 4021 of Box 4020, it would be possible that the prompt is created on the basis of a result of the image processing output (solved on the basis of the output of the foundation model) from the preceding iteration. For example, the result of the image processing output could be evaluated, and the prompt could then be defined in the current iteration 4021 of Box 4020 on the basis of determined deviations from the expected result (for example specified by an annotation by the user). Instead of focusing on the result of the image processing task in such a results-oriented creation of the prompt, it would in an alternative to that or in addition also be conceivable to focus on the output of the foundation model, i.e. the program code created by the foundation model. Thus, it would therefore be conceivable that the prompt in the current iteration 4021 of Box 4020 is created on the basis of the program code created by the foundation model in the preceding iteration 4021. Thus, it would for example be conceivable that the program code is checked by means of a suitable testing algorithm. In that case, it would be conceivable that the prompt in the current iteration 4021 of Box 4020 is created on the basis of the test result from this test of the program code in the preceding iteration. From the statements above, it is evident that a large number of variants are conceivable for creating the prompt in Box 4020.

Should the prompt in Box 4020 be created on the basis of extended information (i.e. information going beyond the user input from Box 4015), it would be conceivable for the corresponding information to be transferred as context information to the foundation model together with the prompt. The prompt may contain an appropriate reference to the context information. For example, it would be conceivable that the result from running the program code or the program code from the preceding iteration 4021 is transferred as context information to the foundation model, with the prompt containing an appropriate reference to this context information and its meaning.

For example, it would be conceivable that the microscope image is transferred to the foundation model as context information together with the prompt. In an alternative to such a transfer of the microscope image to the foundation model or in addition, it would also be conceivable that context data from the image capture of the microscope image are transferred to the foundation model. For example, such context data may contain the utilized objective, the exposure time, certain settings in the image capture software of the microscope, the user, other application data, etc.

Various aspects in the context of the information content used as a basis for creating the prompt were described above. Techniques for creating the prompt are described below. For example, the prompt may be created in Box 4020 on the basis of preassembled text components. In an alternative to that or in addition, it would however also be conceivable that a further text-based model, for example a further text-based foundation model or else a domain-specific machine-learned model specifically trained for this task, is used to create the prompt on the basis of the user input and optional further information, as described above. Formulated in general terms, the prompt in Box 4020 can thus be created by means of a predefined function. The predefined function can select at least one of a programming language for the program code or a plurality of image processing libraries for solving the structure-based image processing output and insert said selection into the prompt as processing procedure. An exemplary prompt is represented in TAB. 1:

TABLE 1
Exemplary prompt. It is evident that the prompt is created on the basis
of a “<USER_REQUEST>” user input.

You are an AI assistant helping an image processing program to understand
user inputs. Specifically, your task consists of translating the user input into a
response that can be processed by an image processing app. Your response must
always be a valid JSON, which represents a dictionary with the keys: “status” and
“code”. Should the user present an input request containing a valid and supported
image processing instruction, the value for the “status” key must be set to
“VALID_REQUEST”. Moreover the “code” field must contain Python code that
precisely performs the calculation requested by the user. The Python code must
consist of a single function called “calculate”, which must accept a single argument
called “image” and must return the result. For the image processing functions, the
Python code must use the modules “cv2”, “scikit-image”, “numpy” or “scipy”. Should
mathematical functions be required, the Python code must use the “math”, “numpy”
or “scipy” modules (in this order) to perform these calculations. Other imports are
not allowed. Imports must always be implemented in the form “import <Name>” and
contained within the “calculate” function. Should the user not request a valid image
processing task, this is indicated by setting the “status” to “INVALID_REQUEST”.
Moreover, the “code” field must be “null” in this case. The start of the user request is
specified by “<USER_REQUEST>”, the end by “</USER_REQUEST>”.

For example, it is evident from TAB. 1 that both positive and negative requirements that exclude certain variants are conceivable. For example, the program code may call operations from one or more image processing libraries. For example, such operations may be selected from the following group: contour finding; threshold value comparison; masking; segmentation, histogram analysis, etc. In this case, such a predefined function may comprise heuristic rules or else also comprise a machine-learned text-to-text model. This may be learned domain-specifically, or else it could be a domain-overarching foundation model.

In this case, some variants of the prompt may contain one or more specific requirements in relation to boundary conditions that are to be used for the program code. Examples of such boundary conditions would for example include the requirement of a specific programming language, the requirement of one or more specific libraries to be used for specific operations to be applied in the context of the image processing task, or else the requirement of specific such operations for running the image processing task. Should the prompt contain no appropriate requirements, it is down to the foundation model to select the appropriate boundary conditions for the program code. However, it is also conceivable that the prompt is created in such a way that appropriate requirements are placed on the foundation model. For example, it would be possible that the prompt already specifies the use of a specific programming language. In an alternative to that or in addition, specific image processing libraries, i.e. collections of image processing operations, may be predetermined. The specific operations to be used could also be predetermined. In an alternative variant, it would be possible that appropriate candidate sets are made available, and the foundation model is requested by appropriate instructions in the prompt to select the specific programming language or the specific library or else a specific image processing operation from the corresponding candidate sets.

In various variants, preassembled program code fragments or program code modules could be listed in the prompt, and the foundation module could be requested to perform a selection of these fragments or modules. Thus, in other words, this means that the foundation model does not generate the program code completely freely in such an example but instead creates appropriate program code from a narrow specification of candidate fragments or candidate modules. This further reduces the complexity of the inference task of the foundation model for creating the program code. This reduction in complexity can be achieved by specifying suitable fragments or modules for certain standard tasks. For example, in the case of object localization, a certain detector model may be selected from a plurality of already trained detector models. For example, such a decision could depend on the microscope image. For example, if the microscope image displays cell nuclei with certain staining, for example with DAPI staining, it is possible to select a first detector model, while a different, second detector model may be selected when cells are imaged with phase contrast. This selection may be made by the machine-learned foundation model but may be prepared by a suitable specification of this selection partial task in the prompt. Such additional information is introduced into the prompt in the intermediate layer. That is to say, the user input need not be indicative of e.g. the program code fragments or program code modules discussed above. The user input need not be indicative of a specific candidate set of libraries for the corresponding programming language. Appropriate information can be introduced into the prompt in the intermediate layer by way of the predefined function.

From the statements above, it is evident that the suitable structuring of the prompt in the intermediate layer between the user input on the one hand and the foundation model on the other hand allows the complexity of the inference task for the foundation model when creating the program code in various implementation methods to vary from very high to relatively low. Depending on the types of requirements made or omitted in the prompt for the foundation model, the complexity of the inference task for creating the program code may vary. It should be understood that the specific choice of complexity for the inference task or degrees of freedom when creating the program code has an influence on the flexibility when treating different image processing tasks. For example, if the complexity is reduced by way of relatively comprehensive requirements in the prompt, it may be conceivable that certain image processing tasks can no longer be solved meaningfully.

However, in some scenarios it would be conceivable that the degree of freedom when creating the program code is adapted iteratively from iteration 4021 to iteration 4021. For example, it would be conceivable that, in an earlier iteration 4021, the program code is created in such a way in Box 4020 that the foundation model only needs to observe a small number of degrees of freedom. For example, it could be possible to precisely specify the programming language to be used, and the image processing libraries to be used might also be predetermined. Should the user then determine that the result of the image processing task is unsatisfactory, the number of degrees of freedom for the foundation model could subsequently be increased by way of a suitable adaptation during the prompt creation. For example, a plurality of different programming languages may be made available selection and/or plurality of different image processing libraries may be made available for selection from a corresponding candidate set in a later iteration 4021 of Box 4020. Then, the foundation model can make a suitable selection from these image processing libraries specified in the candidate set. Should feedback to the effect that the result of the image processing task is still not yet solved satisfactorily subsequently be received from the user, all restrictions in relation to the programming language to be used or in relation to the image processing libraries to be used during the creation of the prompt could be dropped, and the foundation model is then able to create the respective prompt with a large degree of freedom. In this way, a check can be made during the continuous interaction between human and machine as to whether the corresponding image processing task can already be solved with comparatively simple means, or else whether a more complicated inference task for the foundation model is required in order to obtain the desired result.

In Box 4025, it is optionally possible to check the prompt created previously in Box 4020. Such a check of the prompt may be desirable, in particular, if the prompt is not only created by means of heuristic rules but is for example itself created with the aid of the machine-learned text-to-text model. In such a scenario, certain predetermined testing rules can be used to find surprising content of the prompt or content of the prompt that deviates from the norm and optionally suspends the transfer of the prompt to the foundation model.

For example, should the prompt be determined in Box 4025 as not satisfying the requirements of the test, Box 4020 can be carried out again. When Box 4020 is carried out again, the predefined function for creating the prompt can be adapted on the basis of a result of the test from the previously carried out iteration 4021 of Box 4025.

The test of the prompt in Box 4025 may optionally be directed at the content of the image processing task in question. For example, the prompt could be used to validate whether the user input is a user input specifying a valid image processing task. There could be a check as to whether the problem presented by the image processing task is even solvable in principle by way of programming and/or able to be run on available computing resources.

Box 4030 is optionally carried out next. An image description of the microscope image can be created in Box 4030. For example, the properties of the microscope image can be described. It would be possible for the properties of the imaged microscopic structures to be described. Such a textual description can be created by means of a machine-learned image-to-text model, for example a further foundation model. In particular, it would be possible for the foundation model that is subsequently used to create the program code to create such a textual description in a partial task at an earlier stage. Such a textual description can subsequently also be transferred to the foundation model as context information. It was determined that such a textual description allows the program code to be created in a more targeted fashion and in a manner better adapted to the actual image processing task. The complexity of the inference task when creating the program code is reduced by the preceding creation of the textual description.

Accordingly, in an alternative to such a creation of the textual description of the microscope image or in addition, it would also be conceivable that a textual description of an image processing algorithm to be implemented by the program code is created, and this is transferred accordingly to the foundation model as context information. In other words, it would thus be conceivable that the program sequence of the image processing algorithm is acquired textually in advance with a high degree of abstraction (e.g. abstracted from the programming language, for instance in pseudocode) in Box 4030. For example, such a textual description may be created by means of a machine-learned text-to-text model, for example a further foundation model or the foundation model that is subsequently used to create the program code.

In Box 4035, the use of the foundation model is triggered in order to create program code that subsequently allows the structure-based image processing task to be solved. In general, the machine-learned foundation model in Box 4035 may be inferred locally on a computer that also runs the remaining boxes of FIG. 1. However, it would also be conceivable that the foundation model is run on a remote server, for example in the cloud and/or using distributed resources. Depending on where the foundation model is inferred, Box 4035 may thus contain the transmission of appropriate messages, for example via the Internet. The output of the foundation model is also obtained in Box 4035.

The foundation model is usually a large pre-trained language model (e.g. the models known as GPT, LLAMA, Gemini, Falcon, Mistral, etc. available as open source); however, it may also be a self-trained model or model adapted by “fine tuning”. The foundation model understands idiomatic text and is capable of creating program code. In this case, it is optional that the foundation model may also receive further modalities (in particular images) as inputs (“multimodal LLM”). The foundation model is run upon request via an interface on the server/in the cloud.

The program code is obtained as a result of the inference of the foundation model. It may optionally be checked in Box 4040. In Box 4040, it is optionally possible to check the program code which is received as output of the foundation model, i.e. as output of the current iteration 4021 by Box 4035.

On the basis of a result of this test, the program code may then optionally be released to execute the program code (“Yes” branch out of Box 4040) or a further iteration 4021 of Box 4020 may be initiated, i.e. a new prompt may be created for a further inference of the foundation model; when creating the prompt, the result of the test of the program code could be taken into account, as described above.

For example, whether a valid image processing task should be solved by means of the program code could be validated in Box 4040. For example, a comparison with specific image processing libraries or programming languages potentially to be used could be performed, and a check could be carried out whether the program code contains only language elements or calls within these boundary conditions. A check could be carried out that no regulatory requirements are infringed, for example relating to the transmission of sensitive data to a server, etc. A check could be carried out whether the program code utilizes the available computing resources or else requires additional computing resources. A check could be carried out to ensure that the program code does not contain malicious code. For example, the check of the program code could be performed at least in parts by the foundation model from Box 4035. For example, an indicator placed by the foundation model (and triggered by appropriate information in the prompt) could be provided for different sections of the code, with said indicator indicating that a corresponding test by the foundation model was successful. However, in other scenarios, the test of the program code in Box 4040 could be implemented by way of heuristic rules, for example in the context of the allowed programming languages or libraries explained above. Yet a further example includes the use of a further machine-learned model for checking the program code in Box 4040. For example, a further machine-learned model trained specifically for this task could perform the check of the program code. For example, in contrast to the unsupervised or weakly supervised learning of a foundation model, in particular of the foundation model from Box 4035, such a model can be learned by means of a supervised learning step, in which a user creates labels (relating here to the successful or unsuccessful testing of program code training data) in a targeted fashion. This can create greater reliability in the context of testing the program code, even if flexible image processing tasks should be solved by the machine-learned model by means of said program code. Further examples for the implementation of Box 4040 for example contain a static code analysis. For example, such a static code analysis may contain “whitelisting” and/or “blacklisting” of certain image processing libraries or operations within certain image processing libraries. Yet a further example for the implementation of Box 4040 contains the use of a virus scanner, for example for checking for malicious code. However, it would also be conceivable to run an interpreter that checks the executability of the code.

Should Box 4040 determine an error in the program code, there can be a user output to a user as a matter of principle. This user output may contain a result of the test and optionally request the user adapt the user input that underlies the creation of the associated prompt. However, not all variants require a corresponding output to a user. For example, it would be conceivable that a further iteration 4021 is carried out by Box 4020 directly, and a corresponding test result is taken into account in the creation of the corresponding prompt in the subsequent iteration 4021 of Box 4020.

Should the result of the check in Box 4040 be positive, the program code is released, and Box 4045 can subsequently be carried out.

In Box 4045, working through the program code is triggered. Corresponding results data are obtained. The results data solve the image processing task.

As a general rule, it would be conceivable that the program code is drafted at least in part in a source language for a compiler such that Box 4045 may comprise the compilation and subsequent run of a compiled representation of the program code. In an alternative to that or in addition, it would however also be conceivable that the program code comprises script commands that can be executed by an image processing program (without a compilation of the script commands being necessary). Thus, the execution of the program code may comprise a transfer of the script commands to the image processing program. In an alternative to that or in addition, it would also be conceivable that the program code comprises control instructions that can be run by an image processing module of a microscopy system that is for example used to capture the microscope image received in Box 4010. Then, the execution of the program code and hence Box 4045 may comprise the transfer of the control instructions to this image processing module.

From the statements above, it is evident that a comprehensive interaction of the program code with the software environment is conceivable, depending on the implementation of the program code. This is especially the case should the program code be compilable. Accordingly, it may be desirable for the program code to be executed in what is known as a “sandbox environment”. The latter denotes an isolated region within a software environment, wherein running the program code of the isolated region cannot have any effects on the environment of this region (suitable security measures are in place).

Results data that solve the image processing task are obtained by running the program code. The results data may be improved if compared to reference implementations in which no assistance by a foundation model is available. It is optionally possible, in Box 4050, to check these results data and either discard the results data (“No” branch out of Box 4050) or release them (“Yes” branch out of Box 4050), depending on a result of this check. Should the results data not be released in Box 4050, a further iteration 4021 of Box 4020 is created. In this context, it would be conceivable that—as already described above—the prompt created in the next iteration 4021 of Box 4020 is created on the basis of the result from Box 4045, i.e. on the basis of the results data from the preceding iteration 4021, and/or the results data are transferred, at least as context information, to the foundation model in the subsequent iteration 4021 in association with the respective prompt.

The test in Box 4050 may contain a plausibility check or a consistency check, for example. There can be a check as to whether the image processing task is in fact solved. Certain compliance requirements may be checked; for example, there can be a check as to whether the results data contain offensive results.

In Box 4050, it is once again possible to use a different machine-learned model, for example a domain-specific model or a foundation model. It would also be possible to use heuristic rules.

In Box 4055, it is subsequently possible to output the result of running the program code. For example, a corresponding user interface may be configured accordingly. For example, the result may be present in the form of an image, for example if this relates to a semantic segmentation. However, the results data may also be present in the form of a list, for example contain the coordinates of objects found. It would also be conceivable that results data contain a scalar value or a plurality of scalar values. For example, the number of objects present with a certain property could be counted. Appropriate results data may be processed further by means of specific algorithms. For example, in the context of a list of localization information, it would be possible to plot corresponding positions in the microscope image. The output may be implemented via a suitably structured graphical user interface. For example, it would be possible to display the initial microscope image from Box 4010 next to the listing or a corresponding results image based on the results data. Use could be made of a juxtaposed or else superimposed display. Further processed information based on the results data, for example a prepared statistic, a generated plot, etc., could be output to the user.

The result data may be used for controlling a technical device. A practical application may be implemented employing the result data. This practical application may include the utilization of the results generated by the methods described in the disclosure for solving real-world problems or for improving existing technical systems. For example, in the context of microscope image processing, the practical application of the described techniques could involve using the processed images or derived data (e.g., object counts, segmentation masks, etc.) to automate quality control in industrial manufacturing, to assist in medical diagnostics, or to enhance research workflows in biological sciences. The results of the image processing tasks, such as cell counts, anomaly detection, or virtual staining outputs, may be used as input for further analysis or decision-making systems. In this sense, the term “practical application” emphasizes the potential of the disclosed techniques to provide tangible benefits in various fields by enabling users to translate their specific needs into actionable outcomes through the flexible and user-friendly interaction with microscope images and associated processing tasks.

Quality control may refer to processes and systems implemented to ensure that products or materials meet specified quality standards. In the context of microscope image processing, quality control tasks may involve analyzing microscope images to identify defects, anomalies, or other characteristics that are relevant for assessing product quality. For example, in material testing, quality control may include counting specific types of structures (e.g., defects in a semiconductor material) or evaluating their distribution across the sample. The techniques described herein, such as anomaly detection or segmentation of microscopic structures, may be applied to automate such quality control tasks.

Medical diagnosis may refer to the process of identifying diseases or conditions based on observed symptoms and test results. In the context of microscope image processing, medical diagnosis may involve analyzing biological samples (e.g., tissue slices, cell cultures) to identify specific features indicative of a disease or condition. For example, virtual staining techniques described herein could be used to highlight specific cell types or structures in bright-field images, mimicking the effect of chemical stains traditionally used in medical diagnostics. This could assist medical professionals in identifying abnormalities or patterns that are relevant for making diagnostic decisions.

Research workflow may refer to the sequence of steps and processes followed by researchers in conducting scientific experiments and analyzing data. In the context of microscope image processing, research workflows may involve tasks such as counting cells, determining confluence levels, segmenting areas of interest, or performing virtual staining. The techniques described herein could enhance research workflows by automating these tasks, improving accuracy, reducing manual effort, and enabling researchers to focus on higher-level analysis and interpretation of results. For example, a researcher studying cell cultures may use the described methods to quickly obtain quantitative data on cell proliferation rates or identify specific cell types within an image, thereby streamlining their experimental workflow.

Hereinabove, FIG. 1 was explained in the context of a user input in Box 4015 that describes a specific image processing task directed to the microscopic structures shown in a microscope image. However, it would also be possible for the user input 4015 to be drafted more broadly or not specifically relate to the imaged microscopic structures. For example, the user input in Box 4015 could contain control instructions for a microscopy system. A microscopy task implemented by the microscopy system could be specified. For example, in such a case it would be conceivable for a feedback loop from Box 4055 to Box 4005 to be present on the basis of these control instructions, as depicted by the dashed line in FIG. 1. This is because there can be a control of the microscopy system on the basis of these control instructions in the subsequent iteration 4059 of Box 4005. For example, such control instructions for the microscopy system may contain image capturing settings for a subsequent image capture of the microscopy system or a further microscope image. For example, the specific contrast for the image capture could be chosen. However, it would also be conceivable that the use of specific optical filters is specified. A type of the illumination could be specified. The objective to be used could be determined. In addition to such a hardware control, however, it would also be conceivable that specific software modules of the microscopy system are controlled. For example, an image manipulation module of the microscopy system could be controlled. For example, the user input could specify one or more image manipulation operations for the image processing of a microscope image. For example, such image manipulation operations may contain: denoising; brightening; contrast adjustment; histogram manipulation; super-resolution; deconvolution; image expansion; artifact removal; compressed capture; background suppression; etc. Thus, by means of such techniques, it is possible to create a “microscopy copilot functionality” for controlling the microscopy system. In particular, it is typically conceivable that, on the basis of a control software for the microscopy system, corresponding control instructions are also created in a different way. As a result of communication in free-text format, it is possible for the user to create the corresponding control instructions particularly easily, for example without the need for the user to call numerous menus or submenus. For example, it would be conceivable that one or more image processing algorithms used for the image processing of the microscope image are selected. For example, specific image-to-image models, for example machine-learned models, could be selected from a corresponding library. Often, very many image processing algorithms are available, and it may be hardly possible for a user to select the image processing algorithm suited particularly well to their specific image manipulation operation from the corresponding large set.

In such a case of controlling the microscopy system, it is often not necessary to create compilable program code or source code. Rather, it is possible to create control instructions that can be read by a corresponding control software of the microscopy system. For example, such control instructions may be available in a specific format, for example in a text format.

As a general rule, controlling the microscopy system may include outputting a control signal to the microscopy system, the control signal being indicative of control instructions. The term “control signal” may refer to an instruction or command used to direct the operation of a device or system. In the context of microscopy systems, a control signal may be indicative of specific operational parameters or instructions for capturing microscope images, adjusting imaging modalities, or processing image data. Such signals may be generated based on user inputs, foundation model outputs, or feedback from image processing tasks. Control signals may encompass a wide range of functionalities, such as setting the magnification level of an objective lens, configuring illumination settings like brightness or contrast, enabling specific imaging techniques (e.g., phase contrast or fluorescence), or triggering the execution of image processing algorithms. These signals may be transmitted to the microscopy system in various formats, including digital commands, analog signals, or software-specific control codes. In some examples, control signals may also be used to adjust hardware components dynamically during image capture or processing. For example, a control signal could instruct the microscope to switch between different optical filters, adjust focus levels, or modify exposure times based on real-time analysis of the captured images. Additionally, control signals may play a role in feedback loops, where results from image processing tasks are used to refine subsequent operations of the microscopy system. The generation and interpretation of control signals may rely on communication protocols specific to the microscopy system or its control software. These signals may be encoded with metadata, such as timestamps or operation identifiers, to ensure proper sequencing and execution of commands. In certain cases, control signals may also include validation mechanisms to verify their integrity or compatibility with the system's operational capabilities

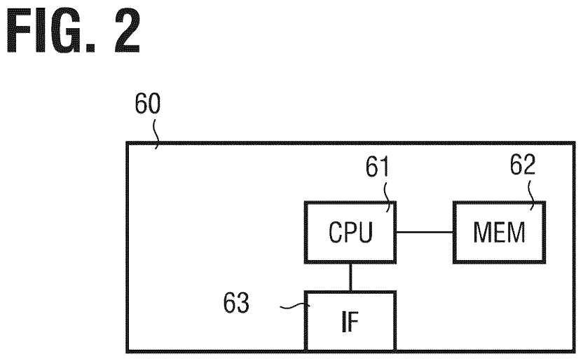

FIG. 2 schematically illustrates an electronic data processing apparatus 60. The data processing apparatus 60 comprises a processor 61 and a memory 62. Moreover, the data processing apparatus also comprises a communications interface 63. The data processing apparatus 60 is configured to carry out at least some of the techniques described herein. To this end, the processor 61 is for example able to load program code 62 from the memory and run said program code. On the basis of the run program code, the processor can run techniques as described above in the context of FIG. 1. For example, via the communications interface 63, the processor is capable of communicating with a server that infers a foundation model in the cloud. Results data may be obtained on the basis of the inference of the cloud model. For example, the processor 61 may also compile a program code and then run the compiled program code, wherein the program code specifies an image processing task in relation to a microscope image, which for example is also received via the communications interface 63. The processor 61 may control a practical application by providing control signals via the communication interface 63. A microscopy system may be controlled. Other technical devices that are different than a microscopy system may be controlled. For instance, a sample processing device may be controlled. A manufacturing line may be controlled.

In summary, techniques according to which an intermediate layer is used between a user and a text-based foundation model were described above. This intermediate layer is used to create a suitable prompt for input into the foundation model and/or to check or validate or test the plausibility of the output from the foundation model. For example, the foundation model may create control instructions for a microscopy system or, in particular, program code for solving an image processing task in association with a microscopy image. For example, the inference of the text-based foundation model may be implemented on a separate server and may be run by way of a program call via a programming interface (application programming interface, API). However, it would also be conceivable that the inference is implemented on a local computer, on which foundation-created program code or foundation-created control instructions is/are subsequently run.

Further summarizing, at least the following EXAMPLES have been disclosed.

EXAMPLE 1.A computer-implemented method for processing microscope images, wherein the method comprises:
receiving (4010) a microscope image,
receiving (4015) a user input in free-text format, the user input being indicative of at least one image processing task for evaluating or manipulating microscopic structures displayed in the microscope image,
the basis of the user input, triggering (4035) the use of a machine-learned text-based foundation model for creating program code that allows the image processing task to be solved, and
triggering (404l ) an execution of the program code and, on the basis thereof, receiving results data.

EXAMPLE 2. The computer-implemented method as described in EXAMPLE 1,
wherein the at least one image processing task comprises a measuring task for determining one or more properties of the microscopic structures contained in the microscope image.

EXAMPLE 3. The computer-implemented method as described in EXAMPLE 1 or 2,
wherein the image processing task creates a virtual contrast for the microscopic structures in a results image.

EXAMPLE 4. The computer-implemented method as described in any of the preceding EXAMPLES,
wherein the creation of the program code comprises one or more iterations (4021), with each iteration of the one or more iterations (4021) comprising:
creating (4020) a respective prompt for the foundation model, and
transferring the respective prompt to the foundation model.

EXAMPLE 5. The computer-implemented method as described in EXAMPLE 4,
wherein in at least one of the one or more iterations, the respective prompt is created on the basis of an output of the foundation model in the preceding iteration, or this output is transferred in association with the respective prompt to the foundation model.

EXAMPLE 6. The computer-implemented method as described in EXAMPLE 4 or 5,
wherein in the at least one of the one or more iterations, the respective prompt is created on the basis of the corresponding prompt from the preceding iteration, or this corresponding prompt is transferred in association with the respective prompt to the foundation model.

EXAMPLE 7. The computer-implemented method as described in any of EXAMPLES 4 to 6,
wherein in the at least one of the one or more iterations, the respective prompt is created on the basis of a corresponding result of the image processing task from the preceding iteration, or this result of the image processing task is transferred in association with the respective prompt to the foundation model.

EXAMPLE 8. The computer-implemented method as described in any of EXAMPLES 4 to 7,
wherein in the at least one of the one or more iterations, the respective prompt is further created on the basis of the corresponding program code from the preceding iteration, or this program code is transferred to the foundation model in association with the respective prompt.

EXAMPLE 9. The computer-implemented method as described in any of EXAMPLES 4 to 8,
wherein in the at least one of the one or more iterations, the respective prompt is further created on the basis of a test result of a test of the corresponding program code from the preceding iteration, or this test result is transferred to the foundation model in association with the respective prompt.

EXAMPLE 10. The computer-implemented method as described in any of EXAMPLES 4 to 9,
wherein the prompt is created by means of a predefined function,
wherein the predefined function selects at least one of a programming language for the program code or one or more image processing libraries for solving the image processing task and inserts said selection into the prompt as processing requirement.

EXAMPLE 11. The computer-implemented method as described in any of EXAMPLES 4 to 10,
wherein, for the creation, the prompt requests the foundation model select one or more image processing libraries from a corresponding candidate set or select one or more operations from an image processing library from a corresponding candidate set.

EXAMPLE 12. The computer-implemented method as described in EXAMPLE 11,
wherein the program code calls operations from the one or more image processing libraries, which are selected from the following group: contour finding; threshold value comparison; masking; segmentation; histogram analysis.

EXAMPLE 13. The computer-implemented method as described in EXAMPLE 11 or 12,
wherein the predefined function comprises one or more predefined heuristic rules and/or comprises a machine-learned text-to-text model.

EXAMPLE 14. The computer-implemented method as described in any of EXAMPLES 4 to 13,
wherein in at least one of the one or more iterations, the respective prompt is checked on the basis of one or more test rules.

EXAMPLE 15. The computer-implemented method as described in any of the preceding EXAMPLES,
wherein triggering the use of the foundation model comprises the transfer of the microscope image to the foundation model.

EXAMPLE 16. The computer-implemented method as described in any of the preceding EXAMPLES,
wherein triggering the use of the foundation model comprises the transfer of context data from an image capture of the microscope image to the foundation model.

EXAMPLE 17. The computer-implemented method as described in any of the preceding EXAMPLES,
wherein triggering the use of the foundation model comprises the transfer of a textual description of the microscope image and/or of the microscopic structures in the microscope image to the foundation model.

EXAMPLE 18. The computer-implemented method as described in EXAMPLE 17,
wherein the textual description of the microscope image is created by means of the foundation model or by means of a further foundation model.

EXAMPLE 19. The computer-implemented method as described in any of the preceding EXAMPLES,
wherein triggering the use of the foundation model comprises the transfer of a textual description of an image processing algorithm to be implemented by the program code to the foundation model.

EXAMPLE 20. The computer-implemented method as described in any of the preceding EXAMPLES, wherein the method furthermore comprises:
on the basis of one or more predefined test rules, testing the program code.

EXAMPLE 21. The computer-implemented method as described in EXAMPLE 20, wherein the method furthermore comprises:
selectively releasing the program code for the execution of the program code on the basis of a test result of the test.

EXAMPLE 22. The computer-implemented method as described in any of the preceding EXAMPLES, wherein the method furthermore comprises:
applying an image evaluation algorithm to the microscope image in order to run a check of one or more properties of the microscopic structures, wherein the creation of the program code and/or the running of the compiled program code is optionally suspended on the basis of a result of the check.

EXAMPLE 23. The computer-implemented method as described in any of the preceding EXAMPLES,
wherein the program code is drafted at least in part in a source language for a compiler, wherein the execution of the program code comprises running a compiled representation of the program code.

EXAMPLE 24. The computer-implemented method as described in any of the preceding EXAMPLES,
wherein the program code comprises script commands that can be executed by an image processing program,
wherein the execution of the program code comprises a transfer of the script commands to the image processing program.

EXAMPLE 25. The computer-implemented method as described in any of the preceding EXAMPLES,
wherein the program code comprises control instructions that can be run on an image processing module of a microscopy system,
wherein the execution of the program code comprises a transfer of the control instructions to the image processing module.

EXAMPLE 26. The computer-implemented method as described in any of the preceding EXAMPLES, furthermore comprising:
checking the results data and optionally releasing the results data.

EXAMPLE 27. A computer-implemented method for controlling a microscopy system for performing a microscopy task, wherein the microscopy task comprises at least one of an image capture of a microscope image, a display of a microscope image and an image processing of a microscope image,
wherein the method comprises:
receiving a user input in free-text format, the user input being indicative of the microscopy task,
on the basis of the user input, triggering the use of a machine-learned text-based foundation model for creating a control instruction for the microscopy system, and
controlling the microscopy system on the basis of the control instruction.

EXAMPLE 28. The computer-implemented method as described in EXAMPLE 27,
wherein the user input specifies one or more image manipulation operations for the image processing of the microscope image.

EXAMPLE 29. The computer-implemented method as described in EXAMPLE 28,
wherein the one or more image manipulation operations are selected from the following group: denoising; brightening; contrast adjustment; histogram manipulation; deconvolution; super-resolution; image enhancement; artifact reduction; compressed sensing/inpainting; background suppression.

EXAMPLE 30. The computer-implemented method as described in any of EXAMPLES 27 to 29,
wherein the user input specifies one or more image capture settings for the image capture of the microscope image.

EXAMPLE 31. The computer-implemented method as described in any of EXAMPLES 24 to 27,
wherein the control instruction specifies or calls one or more image processing algorithms that are used for the image processing of the microscope image.

EXAMPLE 32. An electronic data processing device having a processor and a memory, wherein the processor is configured to load program code from the memory and run said program code, wherein the processor is configured to run a method as described in any of the preceding EXAMPLES on the basis of running the program code.

It goes without saying that the features of the examples and aspects of the invention described above can be combined with one another. In particular, the features can be used not only in the combinations described but also in other combinations or on their own, without departing from the scope of the invention.

Techniques in the context of creating a prompt for a machine-learned text-based foundation model were described above, wherein the prompt causes the foundation model to create control instructions for a microscopy system or, in particular, also program code for an image processing algorithm. The techniques described herein in relation to the intermediate layer between a user and the machine-learned foundation model may however also be applied to other applications outside the context of processing a microscope image or controlling a microscopy system. In particular, techniques in different fields of application may profit from the disclosure described herein. Wherever program code or control instructions are created for technical equipment, it may be advantageous to provide, between the user and the text-based machine-learned foundation model, a corresponding intermediate layer that enables a check of the plausibility of the input, a variation of the prompt, for example over a plurality of iterations, and a check of the output from the foundation model.

Furthermore, techniques were described above for creating conventional program code for solving an image processing task. It would also be conceivable that a prompt for an image-based foundation model is created, rather than program code. For example, image-based foundation models that are based on a vision transformer architecture are known. For instance, one example can be found in Kirillov, Alexander, et al. “Segment anything.” Proceedings of the IEEE/CVF International Conference on Computer Vision. 2023. Such image-based foundation models are capable of solving image processing tasks, e.g. a segmentation or an entity segmentation, in different domains. As input, the image-based foundation models receive the microscope image and optionally a text-based prompt that specifies the tasks that should be solved on the basis of the microscopy image.

1. A computer-implemented method for processing microscope images, wherein the method comprises:
receiving a microscope image,
receiving a user input in free-text format, the user input being indicative of at least one image processing task for evaluating or manipulating microscopic structures displayed in the microscope image,
on the basis of the user input, triggering the use of a machine-learned text-based foundation model for creating program code that allows the image processing task to be solved, and
triggering an execution of the program code and, on the basis thereof, receiving results data.

2. The computer-implemented method as claimed in claim 1, wherein the at least one image processing task comprises at least one of a a measuring task for determining one or more properties of the microscopic structures contained in the microscope image or a virtual contrast for the microscopic structures in results image.

3. The computer-implemented method as claimed in claim 1, wherein the creation of the program code comprises one or more iterations, with each iteration of the one or more iterations comprising:
creating (4020) a respective prompt for the foundation model, and
transferring the respective prompt to the foundation model.

4. The computer-implemented method as claimed in claim 3, wherein in at least one of the one or more iterations, the respective prompt is created on the basis of an output of the foundation model in the preceding iteration, or this output is transferred in association with the respective prompt to the foundation model.

5. The computer-implemented method as claimed in claim 3, wherein in the at least one of the one or more iterations, the respective prompt is created on the basis of the corresponding prompt from the preceding iteration, or this corresponding prompt is transferred in association with the respective prompt to the foundation model.

6. The computer-implemented method as claimed in claim 3, wherein in the at least one of the one or more iterations, the respective prompt is created on the basis of a corresponding result of the image processing task from the preceding iteration, or this result of the image processing task is transferred in association with the respective prompt to the foundation model.

7. The computer-implemented method as claimed in claim 3, wherein in the at least one of the one or more iterations, the respective prompt is created on the basis of the corresponding program code from the preceding iteration, or this program code is transferred to the foundation model in association with the respective prompt.

8. The computer-implemented method as claimed in claim 3, wherein in the at least one of the one or more iterations, the respective prompt is created on the basis of a test result of a test of the corresponding program code from the preceding iteration, or this test result is transferred to the foundation model in association with the respective prompt.

9. The computer-implemented method as claimed in claim 3,wherein the prompt is created by means of a predefined function, and wherein the predefined function selects at least one of a programming language for the program code or one or more image processing libraries for solving the image processing task and inserts said selection into the prompt as processing requirement.

10. The computer-implemented method as claimed in claim 3, wherein, for the creation, the prompt requests the foundation model select one or more image processing libraries from a corresponding candidate set or select one or more operations from an image processing library from a corresponding candidate set.

11. The computer-implemented method as claimed in claim 1, wherein triggering the use of the foundation model comprises the transfer of at least one of the microscope image, context data from an image capture of the microscope image, a textual description of the microscope image and/or of the microscopic structures in the microscope image, or a textual description of an image processing algorithm to be implemented by the program code to the foundation model.

12. The computer-implemented method as claimed in claim 1, wherein the method furthermore comprises on the basis of one or more predefined test rules, testing the program code.

13. The computer-implemented method as claimed in claim 12, wherein the method furthermore comprises selectively releasing the program code for the execution of the program code on the basis of a test result of the test.

14. The computer-implemented method as claimed in claim 1, wherein the method furthermore comprises applying an image evaluation algorithm to the microscope image in order to run a check of one or more properties of the microscopic structures, wherein the creation of the program code and/or the running of the compiled program code is optionally suspended on the basis of a result of the check.

15. The computer-implemented method as claimed in claim 1, wherein the program code is drafted at least in part in a source language for a compiler, and wherein the execution of the program code comprises running a compiled representation of the program code.

16. The computer-implemented method as claimed in claim 1, wherein the program code comprises script commands that can be executed by an image processing program, and wherein the execution of the program code comprises a transfer of the script commands to the image processing program.

17. The computer-implemented method as claimed in claim 1, wherein the program code comprises control instructions that can be run on an image processing module of a microscopy system, and wherein the execution of the program code comprises a transfer of the control instructions to the image processing module.

18. The computer-implemented method as claimed in claim 17, furthermore comprising checking the results data and selectively releasing the results data based on said checking.

19. The computer-implemented method as claimed in claim 1, furthermore comprising employing the result data in a practical application associated with the microscopic structures.

20. A computer-implemented method for controlling a microscopy system for performing a microscopy task, wherein the microscopy task comprises at least one of an image capture of a microscope image, a display of a microscope image and an image processing of a microscope image, wherein the method comprises:
receiving a user input in free-text format, the user input being indicative of the microscopy task, on the basis of the user input, triggering the use of a machine-learned text-based foundation model for creating a control instruction for the microscopy system, and controlling the microscopy system on the basis of the control instruction.

21. (The computer-implemented method as claimed in claim 20, wherein the user input specifies one or more image manipulation operations for the image processing of the microscope image, and wherein the one or more image manipulation operations are selected from the following group: denoising; brightening;
contrast adjustment; histogram manipulation; deconvolution; super-resolution; image enhancement; artifact reduction; compressed sensing/inpainting; background suppression.

22. An electronic data processing device having a processor and a memory, wherein the processor is configured to load program code from the memory and run said program code, wherein the processor, on the basis of the program code, is configured to:
receive a microscope image,
receive a user input in free-text format, the user input being indicative of at least one image processing task for evaluating or manipulating microscopic structures displayed in the microscope image,
on the basis of the user input, trigger the use of a machine-learned text-based foundation model for creating program code that allows the image processing task to be solved, and
trigger an execution of the program code and, on the basis thereof, receiving results data.

23. An electronic data processing device having a processor and a memory, wherein the processor is configured to load program code from the memory and run said program code, wherein the processor, on the basis of the program code, is configured to:
receive a user input in free-text format, the user input being indicative of a microscopy task,
on the basis of the user input, triggering use of a machine-learned text-based foundation model for creating a control instruction for a microscopy system, and
controlling the microscopy system on the basis of the control instruction.
